(19) United States
(12) Patent Application Publication
(10) Pub. No.: US 2005/0169542 A1
(43) Pub. Date: Aug. 4, 2005

(54) Image processing apparatus, image processing method, program, and information recording medium

(76) Inventor: Takanori Yano, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/035,812

(22) Filed: Jan. 14, 2005

(30) Foreign Application Priority Data
Jan. 16, 2004 (JP) 2004-009618
Nov. 10, 2004 (JP) 2004-326084

(51) Int. Cl. G06K 9/36

(52) U.S. Cl. 382/232

(57) ABSTRACT

A technique is provided for efficiently executing image processing operations such as code editing on a specific region of an image in an image processing apparatus for processing encoded image data such as JPEG 2000 encoded data that have a structure enabling data processing in image region units. Upon storing encoded data of an image in a data storage unit, a first table is generated by a table processing unit and includes plural entries corresponding to respective image regions of the image, each entry storing storage address information of code data of its corresponding image region and position information of this image region. Upon processing the image, a second table is generated by the table processing unit according to a process conducted using the table generated upon storing the encoded data of the image as a basis. The second table is referred to by a data processing unit to process the encoded data of the image.

The present application claims priority to corresponding Japanese Application No. 2004-009618, filed on Jan. 16, 2004 and Japanese Application No. 2004-326084, filed on Nov. 10, 2004, the entire contents of which are hereby incorporated by reference.

### BACKGROUND OF THE INVENTION

1. Field of the Invention

The present invention relates generally to the field of image processing, and particularly to processing encoded image data

2. Description of the Related Art

Since image data are generally large in data quantity, image data are often encoded and compressed upon being stored or transmitted.

Image processing such as image editing is generally conducted on image data (pixel value data) of an image. For example, an image editing process may be conducted on pre-encoded source image data as is disclosed in Japanese Patent Laid-Open Publication No. 11-224331. Also, an image editing process may be conducted on decoded image data that are obtained by decoding encoded data of an image as is disclosed in Japanese Patent Publication No. 3251084, for example.

In the method and apparatus disclosed in Japanese Patent Publication No. 3251084, a pointer array for storing a code address for each minimal encoding unit (i.e., 8×8 pixel block for DCT conversion) is used on encoded data of an image (i.e., JPEG encoded data). In an initial state, each pointer of the pointer array points to a corresponding code address of pre-edited encoded data After editing is conducted on a partial region, pointers corresponding to codes of the edited region are updated to point to corresponding code addresses of the edited image data.

In the case of processing encoded data that are encoded according to the JPEG 2000 standard, image processes such as image editing may be realized by accessing code data in image region units (e.g., tiles, or precincts) to conduct code editing, for example.

### SUMMARY OF THE INVENTION

An image processing apparatus, image processing method, program, and information recording medium are described. In one embodiment, the image processing apparatus comprises a storage unit to store encoded data of an image, and a table processing unit to generate a first table for the image stored in the data storage unit. The first table includes a plurality of entries corresponding to image regions of the image, and each of the entries includes storage address information of code data of a corresponding one of the image regions and position information of the corresponding image region.

### BRIEF DESCRIPTION OF THE DRAWINGS

FIG. 1 is a block diagram showing a configuration of an image processing apparatus according to a first embodiment of the present invention;

FIG. 2 is a diagram illustrating a tile division structure of an image;

FIG. 3 is a diagram illustrating a table that is generated upon storing encoded data of an image;

FIG. 4 is a diagram illustrating a structure of an entry corresponding to a tile of the table;

FIG. 5 is a flowchart illustrating an exemplary process flow of the image processing apparatus of the first embodiment;

FIG. 6 is a diagram illustrating an exemplary table that is generated for an image subject to processing;

FIG. 7 is a flowchart illustrating another exemplary process flow of the image processing apparatus of the first embodiment;

FIG. 8 is a diagram illustrating another exemplary table that is generated for an image subject to processing;

FIG. 9 is a diagram illustrating another exemplary table that is generated for an image subject to processing;

FIG. 10 is a diagram illustrating another exemplary table that is generated for an image subject to processing;

FIG. 11 is a flowchart illustrating another process flow of the image processing apparatus of the first embodiment.

FIG. 12 is a diagram illustrating another exemplary table for plural images subject to processing;

FIG. 13 is a block diagram showing a configuration of an image processing system according to a second embodiment of the present invention;

FIG. 14 is a flowchart illustrating a process flow of the image processing system of the second embodiment;

FIG. 15 is a block diagram illustrating a JPEG 2000 encoding process flow;

FIG. 16 is a diagram illustrating an exemplary subband division structure realized by two-dimensional discrete wavelet transform;

FIG. 17 is a diagram illustrating divisions into bit planes and sub bit planes; and

FIG. 18 is a diagram illustrating a data structure of a data stream encoded according to LRCP progression order of JPEG 2000.

### DESCRIPTION OF THE PREFERRED EMBODIMENTS

Embodiments of the present invention include an image processing apparatus and an image processing method for efficiently realizing image processes on encoded image data such as JPEG 2000 encoded image data that are configured to enable data processing in image region units.

According to a first embodiment of the present invention, an image processing apparatus is provided for processing encoded image data having a data structure that enables data processing in image region units, the apparatus includes: a storage unit configured to store encoded data of an image; and a table processing unit configured to generate a first table for the image stored in the data storage unit, the first table including a plurality of entries corresponding to image regions of the image, where each of the entries includes storage address information of code data of a corresponding one of the image regions and position information of the corresponding image region.

According to another aspect of the present invention, an image processing method is provided for reading from a storage unit and processing encoded data of an image, where the encoded data has a data structure that enables data processing in image region units. The method includes: a table processing step of generating a first table for the image to be processed, where the first table includes a plurality of entries corresponding to image regions of the image and each of the entries includes storage address information of code data of a corresponding one of the image regions and position information of the corresponding image region.

According to another aspect of the present invention, a program is provided for administering a computer to function as the respective units of the image processing apparatus of the present invention. According to yet another aspect, the present invention provides a program that is run on a computer for executing at least one of the process steps of the image processing method according to the present invention. According to a further aspect, the present invention provides a computer readable information recording medium that stores the program of the present invention.

According to an embodiment of the present invention, a second table is generated for the image subject to processing, where the second table includes a plurality of entries corresponding to image regions subject to a same process that are consecutively arranged.

According to another embodiment of the present invention, a second table for the image subject to processing is generated in which one or more entries corresponding to one or more specific image regions of the image are deleted.

According to another embodiment of the present invention, a second table for the image subject to processing is generated in which an entry corresponding to a specific image region of the image includes storage address information of code data of another specific image region of the image.

According to another embodiment of the present invention, a second table for the image subject to processing is generated in which an entry corresponding to a specific image region of the image includes position information of another specific image region of the image.

According to another embodiment of the present invention, a second table for the image subject to processing is generated in which an entry corresponding to a specific image region of the image includes storage address information of code data of another specific image region of another image.

According to another embodiment of the present invention, a second table for a plurality of the images subject to processing is generated in which a plurality of tables are coupled to one another, with each of the tables including one or more entries corresponding to one or more image regions of a corresponding one of the images.

In the following, preferred embodiments of the present invention are described with reference to the accompanying drawings.

It is noted that encoded image data that are subject to processing according to an embodiment of the invention correspond to encoded data having a data structure that enables processing in image region units. The JPEG 2000 encoded data may represent an exemplary type of such encoded data. According to an embodiment of the present invention, a table pertaining to encoded data of an image is generated. This table may include entries associated with respective image regions, wherein each entry is arranged to store storage address information of code data of a corresponding image region and position information of the corresponding image region.

In the following examples described in relation to embodiments of the present invention, JPEG 2000 encoded data are used as encoded image data subject to image processing. Thereby, a brief outline of the JPEG 2000 encoding scheme is given below.

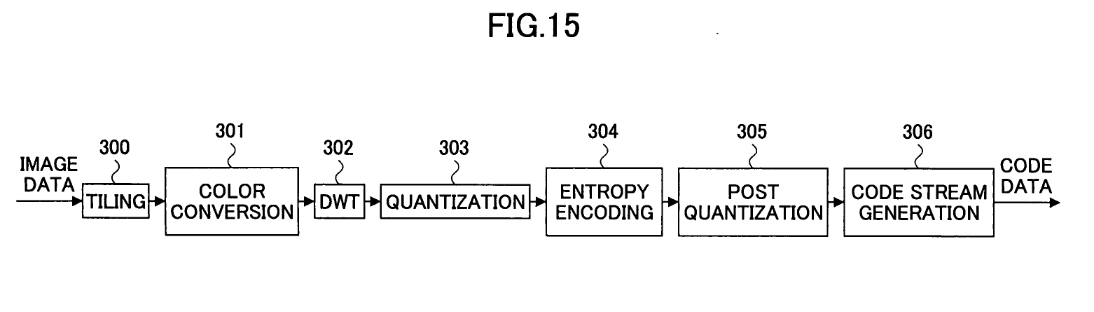

FIG. 15 is a block diagram illustrating a basic encoding process according to the JPEG 2000 encoding scheme. In the following description, it is assumed that image data of colors red, green, and blue (referred to as RGB hereinafter) are handled as input image data.

According to this drawing, at a tiling process unit 300, input RGB image data are divided into non-overlapping rectangular blocks that are referred to as tiles, after which the image data are input to a color conversion process unit 301 in tile units. It is noted that in a case where image data of a raster image is input, a raster/block conversion process may be conducted at the tiling process unit 300.

In the JPEG 2000 scheme, encoding and decoding may be independently conducted on each tile. In this way, the amount of hardware required for realizing encoding/decoding may be reduced. Also, certain tiles may be selectively decoded and displayed. Thus, tiling may contribute to diversifying the functions of the JPEG 2000 scheme. However, it is noted that tiling is an optional process in the JPEG 2000 standard, and thereby, tiling does not necessarily have to be conducted.

Next, the image data are converted into brightness/color difference signals at the color conversion process unit 301. According to the JPEG 2000 standard, two types of color conversion schemes are set corresponding to two types of filters (i.e., a 5×3 filter and 9×7 filter) that are used in the Discrete Wavelet Transform (referred to as DWT hereinafter). It is noted that before conducting the color conversion, DC level shifting may be conducted on each of the R, Q and B signals.

Then, the color converted signals is supplied to a DWT process unit 302 where a two-dimensional Discrete Wavelet Transform (DWT) is conducted on each signal component.

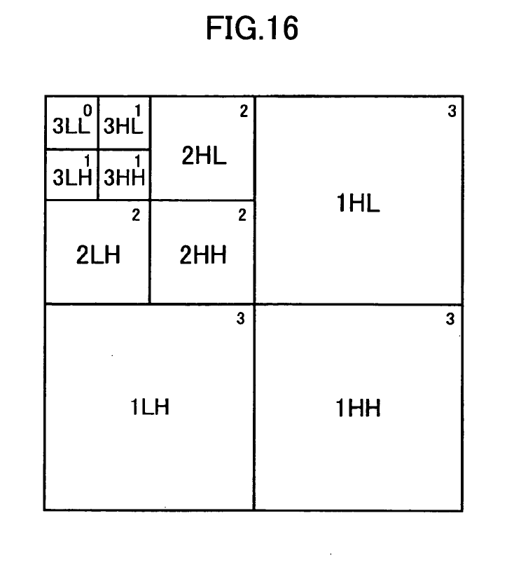

FIG. 16 is a diagram showing wavelet coefficients from an octave division. In DWT, four directional components referred to as subbands LL, HL, LH, and HH are output with respect to each decomposition level, and the DWT is iteratively conducted on the LL subband to increase the decomposition level to a lower resolution. As is illustrated, coefficients of decomposition level 1 with the highest resolution are indicated as 1HL, 1LH, and 1HH; similarly, coefficients of decomposition level 2 are indicated as 2HL, 2LH, and 2HH. FIG. 16 shows a subband division in the decomposition levels. It is noted that the number indicated in the upper right corner of each subband represents the resolution level of the subband.

The subband of each decomposition level may be divided into rectangular regions called precincts to form a set of codes. Further, each precinct may be divided into predetermined rectangular blocks called code blocks, and encoding may be conducted on each of the code blocks.

Then, a quantization process unit 303 conducts scalar quantization on the wavelet coefficients output from the DWT process unit 302. It is noted that in a case where lossless DWT is conducted, the scalar quantization process is not conducted and instead, quantization with a quantization step size of 1 may be conducted. Also, it is noted that effects that are substantially identical to the effects of scalar quantization may be obtained in a post quantization process that is conducted by a subsequent post quantization process unit 305. It is further noted that the parameter used for the scalar quantization may be changed to a unit of tiles, for example.

Then, an entropy encoding unit 304 conducts entropy encoding on the quantized wavelet coefficients that are output from the quantization process unit 303. In an entropy encoding process according to the JPEG 2000 scheme, a subband is divided into rectangular regions that are referred to as code blocks (c.f., however if the size of a subband is smaller than the code block size, such division is not conducted on this particular subband), and encoding may be conducted on each of the code blocks.

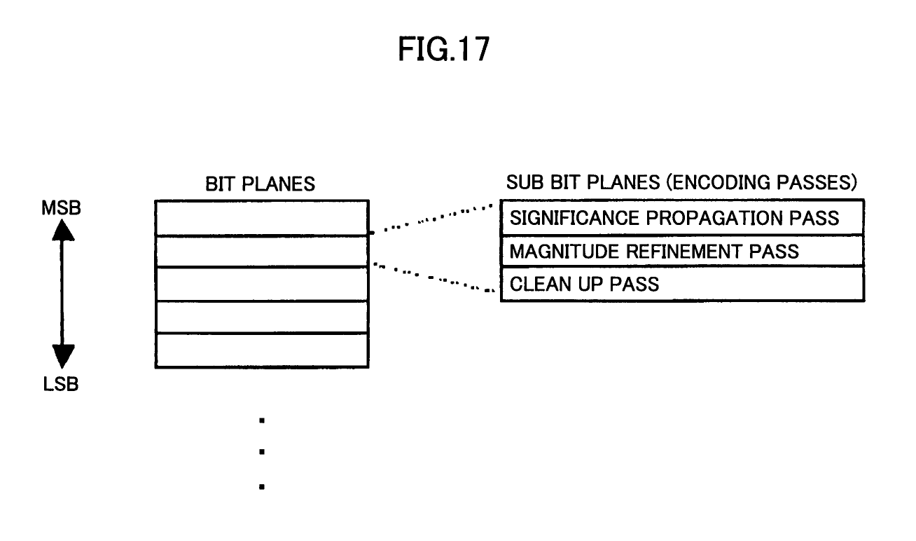

As is illustrated in FIG. 17, in conducting encoding on a code block as is described above, the wavelet coefficients within a code block may be divided into bit planes, and each of the bit planes may be further divided into three encoding passes (i.e., significance propagation pass, magnitude refinement pass, and clean up pass) according to their degree of influence on the image quality, when the passes are referred to as sub bit planes. The sub bit planes may then be encoded by a so-called MQ coder using an arithmetic coding scheme. In FIG. 17, a bit plane positioned closer to the MSB side has a greater significance level (greater influence on the image quality). As for the significance level of the encoding passes, the significance propagation pass may have the highest level of significance, and this level may decrease from the magnitude refinement pass to the clean up pass in this order. Also, the end of each pass may be referred to as a truncation point, and this may be used as a unit for code truncation in a subsequent post quantization process.

A post quantization process unit 305 may conduct code truncation on the encoded data generated by the entropy encoding process as is necessary or desired. However, it is noted that the post quantization process is not conducted in a case where lossless codes need to be output. By conducting the post quantization process, the code amount may be controlled by truncating codes after an encoding process so that feedback for code amount control becomes unnecessary (i.e., one-pass encoding may be realized), which is one of the characteristic features of the JPEG 2000 scheme.

Then, a code stream generating process unit reorganizes the codes of the code data obtained from the post quantization process according to a progressive order, which is described below, and adds a header to the code data to generate a code stream (encoded data).

In the JPEG 2000 scheme, five types of progressive orders are defined according to the priority order of four factors of an image, the factors corresponding to image quality (layer (L)), resolution (R), component (C), and position (precinct (P)), and the possible progressive orders being referred to as LRCP progression, RLCP progression, RPCL progression, PCRL progression, and CPRL progression.

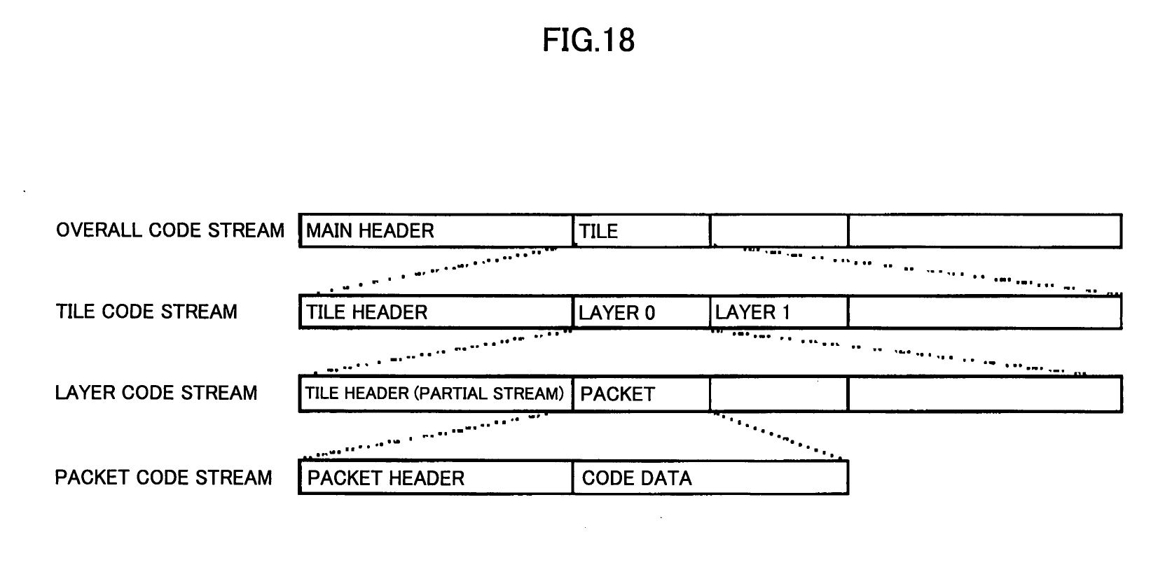

FIG. 18 is a diagram showing a structure of a code stream according to the RLCP progression of JPEG 2000. The illustrated code stream basically corresponds to code data including a main header and at least one tile. According to the RLCP progression scheme, code data of each tile includes a tile header and plural layers that correspond to code units into which codes within a tile are divided (described in detail below). The layers are arranged in order starting from the top layers: layer 0, layer 1, . . . , and so on. A layer includes a layer tile header and plural packets, and a packet includes a packet header and code data. A packet corresponds to the smallest unit of code data, and corresponds to code data of one layer within one precinct of one resolution level (decomposition level) within one tile component.

It is noted that the decoding process according to the JPEG standard may be realized by reversing the processes described above, and thereby descriptions thereof are omitted.

### An Exemplary Embodiment

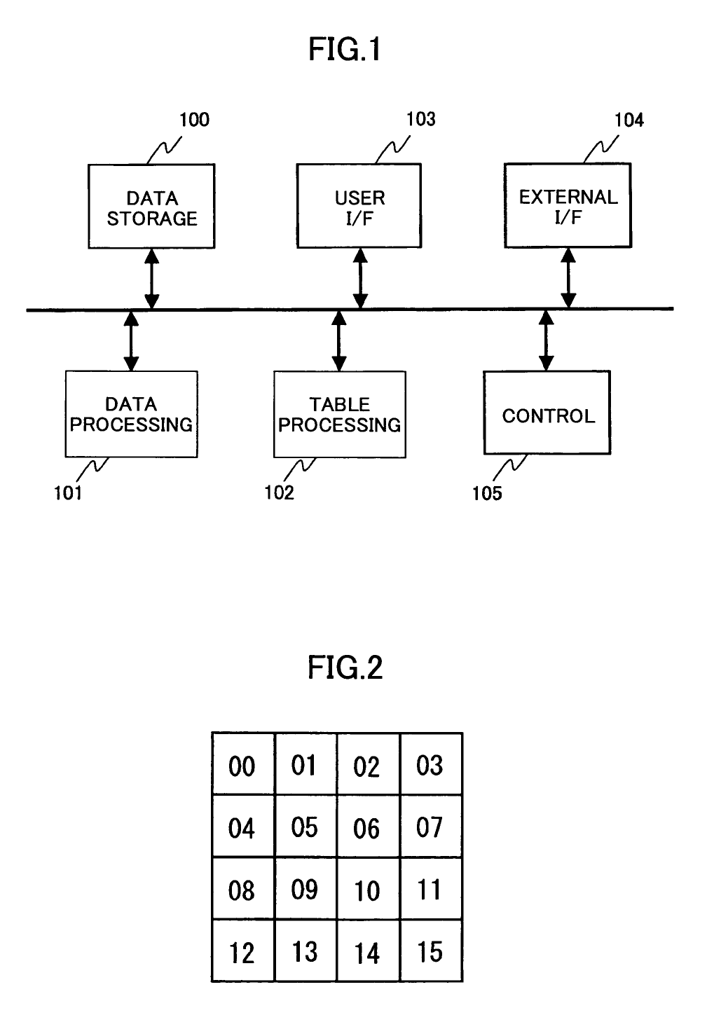

FIG. 1 is a block diagram showing a configuration of an image processing apparatus according to an embodiment of the present invention. The image processing apparatus shown in this drawing includes a data storage unit 100, a data processing unit 101, a table processing unit 102, a user interface unit 103, an external interface unit 104, and a control unit for controlling the operations of the above units.

The units of the image processing apparatus may be arranged to exchange information with each other to conduct an imaging operation.

In the illustrated image processing apparatus, encoded data of an image that are stored in the data storage unit 100 maybe processed. For example, the encoded data of an image that are stored in the data storage unit 100 may correspond to data acquired through the external interface unit 104. It is noted that the encoded image data is arranged to have a data structure that enables processing in image region units, and in the following description, it is assumed that the encoded data correspond to JPEG 2000 encoded data.

The data processing unit 101 is arranged to process encoded image data. For example, the data processing unit 101 may be arranged to conduct a code editing process, a decoding process, and/or an image reconstructing process. The data storage unit 100 may be used as a working memory area for executing such operations.

The table processing unit 102 is arranged to generate a table pertaining to an image. A table generated by the table processing unit 102 includes entries that are associated with respective image regions. It is noted that in JPEG 2000 encoded data, tiles, precincts, and code blocks may be used as image region units. However, in order to simplify the following descriptions, it is assumed that tiles are used as the image region units. It is noted that depending on the process being executed, a code editing process may be substantially completed by the completion of table generating process by the table processing unit 102. The data storage unit 100 may also be used as a storage area for storing for storing the table generated by the table processing unit 102.

The user interface unit 103 is arranged to provide an interface between the image processing apparatus and a user for designating/displaying an image subject to processing, directing an image processing operation, and/or designating an image region with respect to image processing, for example.

According to an embodiment, the above-described image processing apparatus may be realized by one or more programs that are operated on an operating system by a computer including a CPU, a main memory, an auxiliary storage unit such as a hard disk unit, a medium drive unit for reading/writing information from/on an information recording medium such as an optical disk a communication interface, and an external interface, for example. In such a case, the user interface unit 103 may correspond to a computer display apparatus and a user input apparatus. The data storage unit 100 may correspond to a storage space provided by the main memory and/or the auxiliary storage unit of the computer Also, an information recording medium such as an optical disk that is installed in the medium drive unit of the computer may also be implemented as the data storage unit 100. The external interface unit 104 may correspond to the external interface and/or the communication interface of the computer. The medium drive unit may also be implemented as the external interface unit 104. In a case where a hardware encoder/decoder unit according to the JPEG 2000 standard is provided in the computer, such an encoder/decoder unit may also be implemented as an encoding/decoding function of the data processing unit 101.

It is noted that other embodiments of the present invention include one ore more programs for enabling a computer to realize respective functions of an image processing apparatus according to an embodiment of the present invention. Also, embodiments of the present invention include computer readable information recording media such as a magnetic disk, an optical disk, a magneto-optical disk, and a semiconductor memory unit that store one or more programs according to embodiments of the present invention. Further, embodiments of the present invention include one or more computer programs for enabling a computer to execute process steps of an image processing method according to an embodiment of the present invention, and various forms of computer readable information recording media storing such program.

In the following, operations of the image processing apparatus according to the present embodiment are described.

### Table Generation upon Storing Encoded Data

According to an embodiment, in response to a control operation by the control unit 105, encoded data of an image are acquired through the external interface unit 104 to be stored in the data storage unit 100. Upon storing the encoded image data in the data storage unit 100, a table pertaining to the image is generated by the table processing unit 102.

In a case where the image processing apparatus of the present invention is realized by a computer, encoded data of an image maybe acquired through an external interface or a communication interface of the computer, for example. Alternatively, encoded data of an image may be read from an information recording medium through a medium drive unit and stored in a main memory or an auxiliary memory unit. Then, a table generation process may be executed by the CPU and a table may be generated at the main memory.

FIG. 2 illustrates an example in which an image is divided into 16 tiles (image regions) that are numbered from 00 through 15 to generate encoded data of the image. According to this example, the corresponding encoded data includes a main header followed by encoded data of the tiles numbered from 00 through 15.

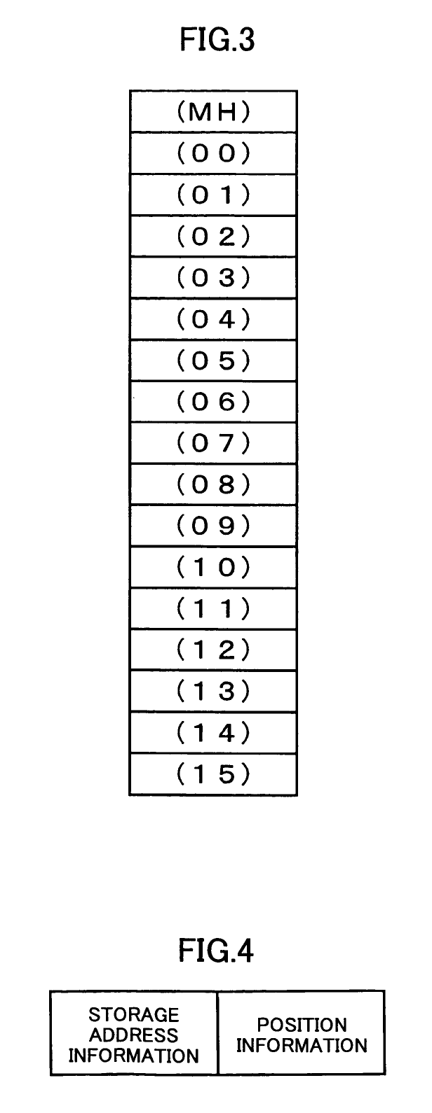

FIG. 3 illustrates a table that may be generated by the table processing unit upon storing the encoded data of the image of FIG. 2 in the data storage unit 100. As is shown in this drawing, the generated table includes an entry corresponding to the main header of the encoded data followed by entries corresponding to the encoded data of the tiles numbered 00-15 in consecutive order. As is shown in FIG. 4, each of the entries corresponding to the respective tiles may be arranged to include storage address information for the encoded data of a corresponding tile (e.g., start address and end address of the stored encoded data) and tile position information of the corresponding tile (e.g., coordinates of upper left corner). The position information for each tile may be obtained through analysis of the main header of the encoded data, for example. It is noted that the entry corresponding to the main header merely includes storage address information and the portion of this entry corresponding to position information may be invalid.

By referring to the table as described above, encoded data of a given image region of the encoded image data may be easily accessed. Also, a table may be easily generated for conducting a particular process as is described below.

As is described below in relation to process examples 2 and 3, position information may be omitted from the entries of a table depending on the actual process to be conducted on encoded data. Also, it is noted that according to an embodiment, the data processing unit 101 may be arranged to include an encoding process function to conduct an encoding process on image data acquired from an external source to generate encoded data of the image data and store the generated encoded data in the data storage unit 100.

In the following, operations relating to specific processes are described.

### An Exemplary Process

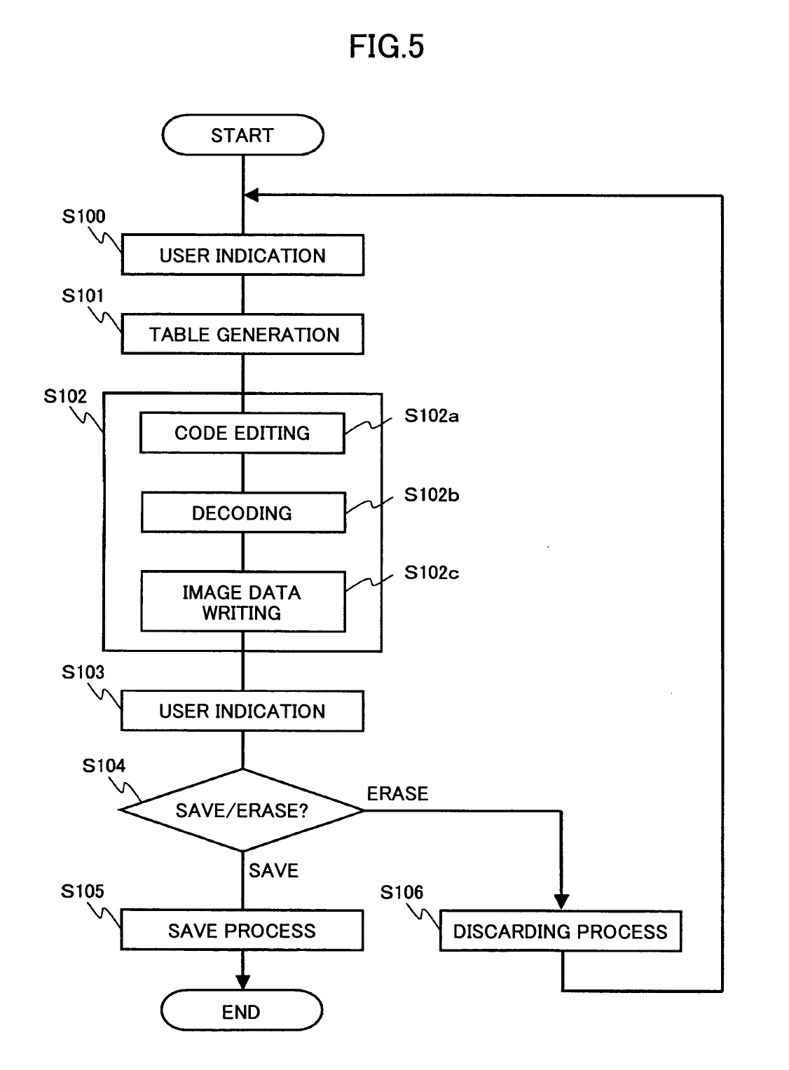

As a first example, an operation is described involving conducting a code editing process for reducing the amount of code data on a specific tile and reproducing an image including this tile. FIG. 5 is a flowchart illustrating a process flow of such an operation.

According to the present example, before starting the present operation, an image that is to be subject to processing is selected by a user. The selection may be made according to conventional methods using the user interface unit 103 to select an image from a list of file names or thumbnail images, for example. Then, encoded data of the selected image are decoded by the data processing unit 101 and image data of the selected image are generated at a predetermined storage area of the data storage unit 100 to be displayed on a screen by the user interface unit 103, for example. In this case, tile division lines are preferably displayed along with the displayed image data.

It is noted that, since the file division structure may be determined by analyzing the main header, according to an embodiment the data processing unit 101 may be arranged to merely analyze the main header to display only the tile division lines. However, the entire image is preferably displayed so that the image quality of the specific tile after code reduction may be compared with the image quality of the rest of the tiles.

Also, it is noted that in a case where the tile division structure is known beforehand, image data indicating the tile division lines corresponding to the tile division structure may be generated at the data processing unit 101 without having to access the encoded data of the image, and the division line image data may be written on a predetermined storage area of the data storage unit 100 so as to be displayed on a screen, for example.

Referring to FIG. 5, first in step S100, a user indicates a particular tile (indication of the image region subject to processing) and indicates the code reduction process (indication of a process) using the user interface unit 103. For example, the indication may be made using a pointing device such as a mouse to select a particular tile or a particular processing command from a screen.

In the following description, it is assumed that an image that is divided into tiles as is illustrated in FIG. 2 is selected for processing, and the twelve tiles surrounding the outer periphery of the image (i.e., files 00-04, 07, 08, and 11-15) are designated as image regions that are subject to processing.

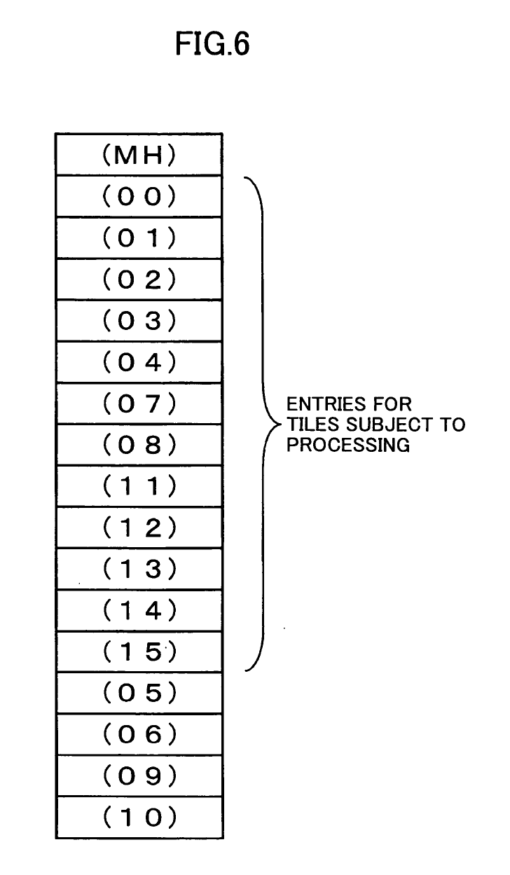

In step S101, the table processing unit 102 generates a table as is illustrated in FIG. 6. Specifically, the table processing unit 102 rearranges the entries of the table generated at the time the encoded image data are stored (the table shown in FIG. 3) in a manner such that the entries for the tiles designated by the user are arranged to succeed one after the other.

Then, in step S102, the table processing unit 101 refers to the entries of the table shown in FIG. 6 starting with the top entry, and based on the storage address information stored in each entry, acquires from the data storage unit 100 code data of the main header and subsequently reads code data of the tiles 00-04,07,08, and 11-15 in this order, one tile at a time. Then, in step S102a, a code editing process for reducing the amount of codes is successively conducted on code data of each of the tiles read from the data storage unit 100. Then, in step S102b, a decoding process is successively conducted on the edited code data of each of the tiles, and in step S102c, the decoded file image data of each of the tiles is written on a predetermined storage area of the data storage unit 100 according to position information stored in the entry for the corresponding file. The above-described process sequence of steps S102a through S102c is successively conducted from each tile until reaching tile 15. It is noted that the code editing process for reducing a code amount of a tile conducted in the present example may correspond to a process of discarding codes (truncation) for each layer, bit plane, or sub bit plane, for example, and re-writing the tile header accordingly. JPEG 2000 encoded data enables such code editing process to be conducted with ease.

According to the present example, in a case of conducting the same process (i.e., code editing process for reducing the amount of codes) on code data of tiles at non-consecutive positions, code data of the tiles subject to processing may be successively read and processed by referring to the table with the rearranged entries, thereby realizing efficient processing of the tiles. It is noted that since position information is stored in the entry of each tile, even when the order of the entries in the table (reading order of encoded data of the tiles) differs from the original order, decoded image data of each tile may be written in accordance with the original positioning of the image data, and thereby, the positioning of the tiles in the reproduced image may not be disrupted.

Also, according to the present example, image data stored in a predetermined storage area of the data storage unit 100 may be displayed on a screen by the user interface unit 103, and thereby, the user may be able to check the result of the code editing process right away. Then, in step S103, the user may indicate whether the result of the code editing process is to be saved or erased by selecting either a ‘SAVE’ command or an ‘ERASE’ command using the user interface unit 103.

When the user selects the ‘SAVE’ command (step S104, SAVE), the table processing unit 102 conducts an operation of rewriting storage address information of corresponding entries of the table based on storage address information of the edited code data of the tiles that are stored in the data storage unit 100 during the process stage of step S102, and conducts a process of saving the re-written table with a new file name (step S105). It is noted that upon saving this table, the order of the entries of the table maybe rearranged back into numerical order of the corresponding tiles.

By conducting the save process as is described above, encoded image data generated as a result of the code editing process may be saved as a different image from the original image. Then, this table be referred to as necessary or desired, and the edited code data may be decoded and an image may be reproduced based on the decoded image data. In this respect, the present process may be regarded as a process of generating a different set of encoded data in which codes of a particular tile are reduced.

On the other hand, when the user selects the ‘ERASE’ command (step S104, ERASE), the data processing unit 101 discards the table generated in step S101, and also discards the edited code data of the tiles stored in the data storage unit 100 during the process stage of step S102 (step S106). Then, the operation goes back to step S100 where the user may select an image region and process once more. Also, the user may select an ‘END’ command to end the processing operation on the present image.

It is noted that in the above-described example, a code editing process for reducing the amount of code data is conducted. However, other code editing processes may be conducted such as a code editing process of discarding color difference component codes of a particular tile to display a monochrome image, a code editing process of changing the progressive order, or a code editing process of lowering the resolution, for example.

Also, in the present process example, another code editing process may be may be conducted on the tiles in the central region of the image after the code editing process of the tiles of the peripheral region of the image. The tiles of the central region (i.e., tiles 05, 06, 09, and 10) are also positioned in a non-consecutive manner, but their corresponding entries are successively arranged in the table so that efficient processing may be realized on these tiles.

It is noted that in a case where the main header needs to be re-written as a result of the code editing process, the re-written main header may be generated and saved before saving the table, and the storage address information stored in the entry for the main header may be re-written accordingly

### Another Exemplary Process

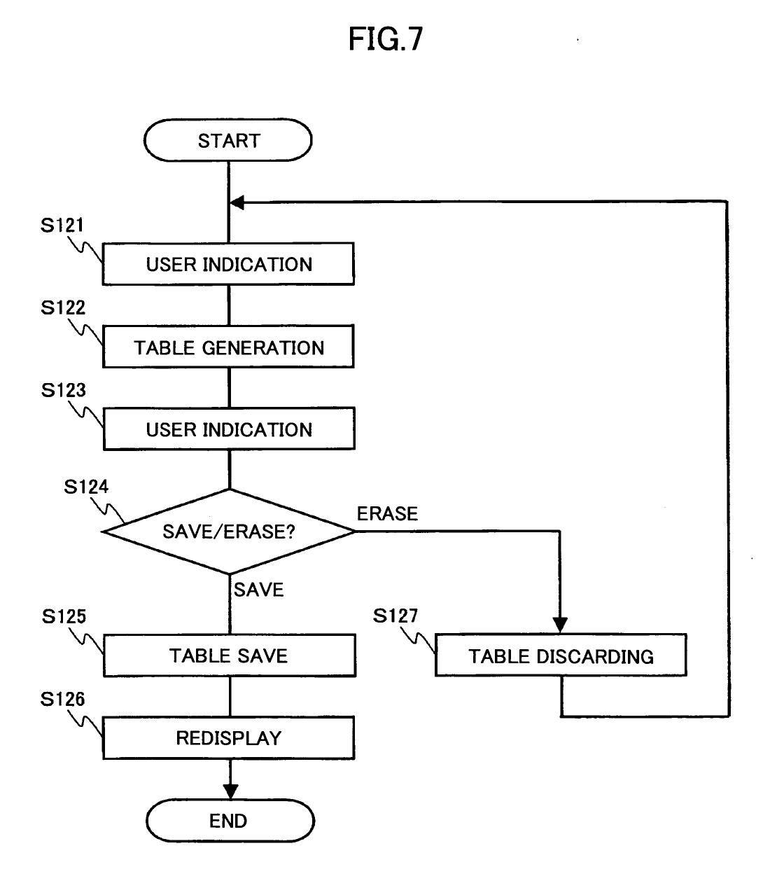

As a second example, a process of interchanging particular image regions is described. FIG. 7 is a flow chart illustrating the process flow of such an operation.

According to the present example, before starting the present operation, an image that is to be subject to processing is selected by a user. The selection may be made according to conventional methods using the user interface unit 103 to select an image from a list of file names or thumbnail images, for example. Then, encoded data of the selected image are decoded by the data processing unit 101 and image data of the selected image are generated at a predetermined storage area of the data storage unit 100 to be displayed on a screen by the user interface unit 103, for example. In this case, tile division lines are preferably displayed along with the displayed image data.

It is noted that, since the tile division structure may be determined by analyzing the main header, according to an embodiment the data processing unit 101 may be arranged to merely analyze the main header to display only the tile division lines. However, it is generally preferred that the entire image be displayed so that the image contents of the image regions may be perceived upon designating the particular image regions subject to the interchanging process.

Also, it is noted that in a case where the tile division structure is known beforehand, image data indicating the tile division lines corresponding to the tile division structure may be generated at the data processing unit 101 without having to access the encoded data of the image, and the division line image data may be written on a predetermined storage area of the data storage unit 100 so as to be displayed on a screen, for example.

Referring to FIG. 7, in step S121, the user indicates a process to be conducted and a set of tiles that are to be interchanged using the user interface 103. The indication may be made by selecting a command and a set of tiles from a screen through the use of a pointing device such as a mouse. In the present example, it is assumed that pairs of tiles 00 and 03, 04 and 07, 08 and 11, and 12 and 15 of the tile-divided image of FIG. 2 are designated as tiles that are to be interchanged.

In step S122, the table processing unit 102 generates (duplicates) a table that is identical to that generated upon storing the encoded data of the relevant image. It is noted that the table referred to in the following description corresponds to this duplicated table. Then, the table processing unit 102 conducts a process of interchanging (exchanging) the storage address information of the entries in the table that correspond to the respective tiles designated for the interchanging process.

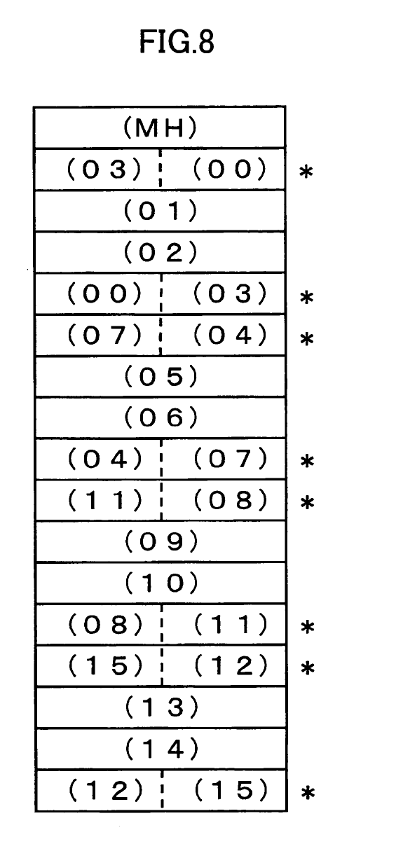

FIG. 8 illustrates a table resulting from such an exchanging process. In the table shown in FIG. 8, the entries with the asterisk marks (*) attached thereto correspond to the entries on which the exchanging of storage address information are conducted. Also, each of the entries for which the storage address information is exchanged is divided by a dashed line, wherein the number indicated at the left side of the entry represents storage address information and the number indicated at the right side of the entry represents position information, the respective sets of information being represented in terms of tile numbers for the sake of convenience. For example, the entry corresponding to tile number 00 has the number ‘03’ indicated at its left side, and this means that the storage address information of the present entry has been re-written to include the storage address information of encoded data of the tile 03. The position information of the entries remain the same.

The code editing process of interchanging designated tiles of an image according to the present example may be substantially completed by conducting the table generation process as is described above. However, it is noted that the actual code data of the designated tiles are interchanged in the process stage of step S126.

In step S123, the user may indicate whether to save or erase the generated table. Specifically, the user may select a ‘SAVE’ command if he/she wishes to save the generated table, and the user may select an ‘ERASE’ command if he/she wishes to erase the generated command using the user interface unit 103.

If the user selects the ‘SAVE’ command (step S124, SAVE), the table processing unit 102 conducts a process of saving the generated table with anew file name (step S125). Then, in step S126, the data processing unit 101 successively refers to the entries of the table saved in step S125 to successively read the code data of the main header and the respective tiles from the data storage unit 100. It is as this process stage that the code data of the designated tiles are actually interchanged. Then, the read code data are successively decoded, and the decoded data of the respective tiles of the present image are written according to the position information stored in the corresponding entries of the table. In this way, an image resulting from the tile exchange process may be displayed by the user interface unit 103.

In a case where the generated table is saved as described above, the image resulting from the tile exchange process may be displayed as necessary or desired by administering the data processing unit 101 to refer to the saved table to conduct a decoding process on the code data of the relevant image. That is, the present process may correspond to a process of generating a different image by exchanging the image content of specific tiles. It is noted that the original image also remains stored in the data storage unit 100 so that it may be reproduced as necessary or desired.

In the present process example, the positioning of the tiles is not changed, and thereby, an image maybe reproduced without disrupting the positioning of the tiles even when the position information is not stored in the entries of the tiles. In the case of conducting a code editing process in which the positioning of the tiles is not changed as in the above example, according to an embodiment, the table may be arranged to include entries storing only the storage address information of the code data of the respective tiles. However, it is noted that by storing the tile position information of the respective tiles in the entries, processes in which changes occur in the tile positioning such as a process of deleting a portion of tiles may be easily conducted along with the interchanging process of designated tiles.

When the user selects the ‘ERASE’ command (step S124, ERASE), the table processing unit 102 conducts a process of discarding the table generated in step S122 (step S127). In this case, the operation goes back to step S 121 where the user may indicate specific tiles to be interchanged once more. Also, it is noted that the user may end the processing of the presently selected image by selecting an ‘END’ command.

It is noted that in the above-described example, one tile is interchanged with another tile. However, according to an embodiment, plural tiles may be interchanged by one tile. For example, tiles 01-03 maybe interchanged with tile 00. In this case, a tile image identical to that of tile 00 maybe indicated at the tile positions of tiles 01-03.

According to another embodiment, in step S125, the position information of the entries corresponding to the designated tiles may be interchanged instead of interchanging the storage address information of the entries. An image with interchanged tile images may similarly be displayed by such a process of interchanging the position information of the designated tiles.

### Another Exemplary Process

In the second example, a process of interchanging specific tiles within the same image is described. As a third example, a process of interchanging one or more specific tiles of an image subject to processing with one or more specific tiles of at least one other image (referred to as used image hereinafter) is described.

In this process example, an image subject to processing (processing image) and a used image are selected by a user beforehand. In turn, the encoded data of the image subject to processing and the encoded data of the used image are decoded by the data processing unit 101 so that the decoded image data of the respective images are generated at specific storage areas of the data storage unit 100 and displayed by the user interface unit 103. In this case, tile division lines are preferably displayed along with the image.

In the following, the present process example is described with reference to the process flowchart of FIG. 7. In step S121, the user uses the user interface 103 to indicate a process to be conducted and tiles of the processing image and the used image, respectively, that are to be interchanged. The indication maybe made by selecting a command and a set of tiles from a screen through the use of a pointing device such as a mouse. In the present example, it is assumed that four tiles numbered 05, 06, 09, and 10 located at the central portion of the processing image are designated to be interchanged with specific tiles of the used image (e.g., tiles 05, 06, 09, and 10).

In step S122, the table processing unit 102 generates (duplicates) a table that is identical to that generated upon storing the code data of the relevant image. Then, the table processing unit 102 refers to the table of the processing image (duplicated table) and the table of the used image (the table generated upon storing the encoded data thereof) to rewrite the storage address information of entries corresponding to the tiles of the processing image that are designated for the interchanging process into the storage address information of entries corresponding to the designated tiles of the used image.

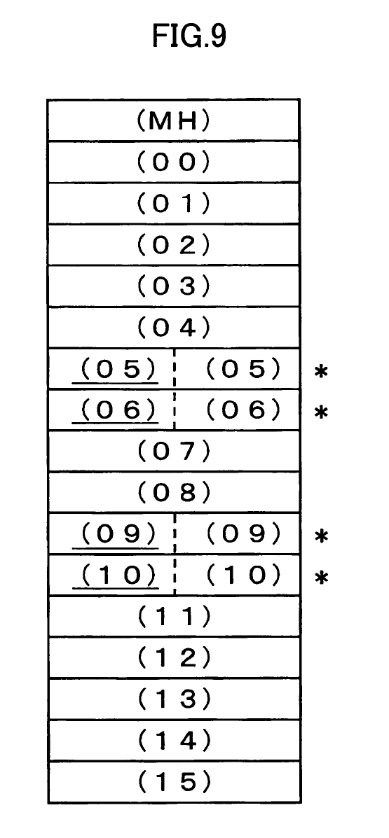

FIG. 9 illustrates a table resulting from such a rewriting process. In the table shown in FIG. 9, the storage address information of the entries corresponding to the four designated tiles with the asterisk marks (*) attached thereto are rewritten. In this example, the position information of the respective entries remains the same.

The code editing process of interchanging the designated tiles of the processing image with the designated tiles of the used image according to the present example may be substantially completed by conducting the table generation process as is described above. However, it is noted that the actual code data of the designated tiles are interchanged in the process stage of step S 126.

In step S123, the user may use the user interface unit 103 to indicate whether to save or erase the generated table. Specifically, the user may select a ‘SAVE’ command if he/she wishes to save the generated table, and the user may select an ‘ERASE’ command if he/she wishes to erase the generated command.

If the user selects the ‘SAVE’ command (step S124, SAVE), the table processing unit 102 conducts a process of saving the generated table with a new file name (step S125). Then, in step S126, the data processing unit 101 successively refers to the entries of the table saved in step S125 to successively read the code data of the main header and the respective tiles from the data storage unit 100. It is as this process stage that the code data of the designated tiles are actually interchanged. Then, the read code data are successively decoded, and the decoded data of the respective tiles of the present image are written according to the position information stored in the corresponding entries of the table. In this way, an image resulting from the tile exchange process of the present example may be displayed by the user interface unit 103.

In a case where the generated table is saved in the manner described above, the image resulting from the tile exchange process may be displayed as necessary or desired by administering the data processing unit 101 to refer to the saved table to conduct a decoding process on the code data of the relevant image. That is, the present process may correspond to an image synthesizing process of generating a different image by interchanging the image content of specific tiles of an image with specific files of another image. It is noted that the original image also remains stored in the data storage unit 100 so that it may be reproduced as necessary or desired.

In the present process example, the positioning of the tiles is not changed, and thereby, an image may be decoded and reproduced without disrupting the positioning of the tiles even when the position information is not stored in the entries of the tiles. Thereby, according to an embodiment, the table may be arranged to include entries storing only the storage address information of the code data of the respective tiles in consecutive order.

When the user selects the ‘ERASE’ command (step S124, ERASE), the table processing unit 102 conducts a process of discarding the table generated in step S122 (step S127). In this case, the operation goes back to step S121 where the user may restart the operation by designating specific tiles to be processed. Also, it is noted that the user may end the processing of the presently selected image by selecting an ‘END’ command.

### Another Exemplary Process

As a fourth example, a process of reproducing a specific region of an image is described.

Before the present process is executed, an image subject to processing is selected by a user through use of the user interface unit 103. In turn, the encoded data of the selected image are decoded by the data processing unit 101 and the decoded image data are generated at a specific storage area of the data storage unit 100 to be displayed by the use interface unit 103. In this case, tile division lines are preferably displayed along with the image.

It is noted that, since the tile division structure maybe determined by analyzing the main header, according to an embodiment the data processing unit 101 may be arranged to merely analyze the main header to display only the tile division lines. However, it is generally preferred that the entire image be displayed so that the image content may be perceived upon selecting an image region subject to the present process. Also, it is noted that in a case where the tile division structure is known beforehand, image data indicating the tile division lines corresponding to the tile division structure may be generated at the data processing unit 101 and displayed.

In the following, the present process example is described with reference to the process flowchart of FIG. 7. In step S121, the user uses the user interface 103 to indicate a process to be conducted and one or more tiles to be reproduced. The indication may be made by selecting a command and one or more tiles from a screen through the use of a pointing device such as a mouse.

In the present example, it is assumed that four tiles numbered 05, 06, 09, and 10 located at the central portion of the present image are designated to be reproduced.

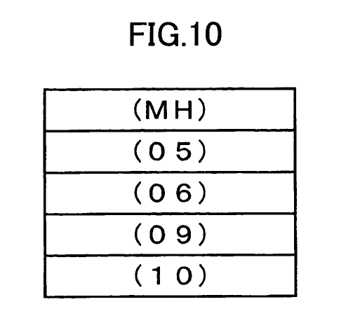

In step S122, the table processing unit 102 generates a table as is shown in FIG. 10 including entries corresponding to a main header and the designated tiles based on the table generated upon storing the encoded data of the present image (table of FIG. 3). In this step, a main header is generated by conducting necessary rewriting processes on the original main header, and the generated main header is stored in the data storage unit 100. Then, the table processing unit 102 writes the storage address information of the generated main header in its corresponding entry within the generated table.

It is noted that in the present example, the positioning of the selected tiles is not changed, and thereby, the position information stored in the entries of the respective tiles remains the same. However, in a case where separately located tiles such as tiles 00, 03, 12, and 15 are designated to be reproduced as a continuous 2×2 tile image, for example, the position information stored in the entries of the respective tiles need to be rewritten.

In step S123, the user may use the user interface unit 103 to indicate whether to save or erase the generated table. Specifically, the user may select a ‘SAVE’ command if he/she wishes to save the generated table, and the user may select an ‘ERASE’ command if he/she wishes to erase the generated command.

If the user selects the ‘SAVE’ command (step S124, SAVE), the table processing unit 102 conducts a process of saving the generated table with a new file name (step S125). That is, an image made up of the four designated tiles is saved as another image. Then, in step S126, the data processing unit 101 discards the image data stored in the specific storage area of the data storage unit 100 (i.e., image data that are presently displayed) and refers to the entries of the table saved in step S125 to successively read and decode the code data of the main header and the designated tiles from the data storage unit 100. Then the decoded image data of the respective tiles of the present image are written according to the position information stored in the corresponding entries of the table. In this way, the image of the four tiles located at the central portion of the original image may be displayed by the user interface unit 103.

In a case where the generated table is saved in the manner described above, the image of the four central tiles may be displayed as necessary or desired by administering the data processing unit 101 to refer to the saved table to read the code data of the main header and the four tiles and conduct a decoding process on the code data. That is, the present process may correspond to a process of generating another image by extracting specific tiles of an original image. It is noted that the original image also remains stored in the data storage unit 100 so that it may be reproduced as necessary or desired.

When the user selects the ‘ERASE’ command (step S124, ERASE), the table processing unit 102 conducts a process of discarding the table and the main header generated in step S122 (step S127). In this case, the operation goes back to step S121 where the user may restart the operation by designating specific tiles to be processed. Also, it is noted that the user may end the processing of the presently selected image by selecting an ‘END’ command.

It is noted that the four specific process examples described above may also be combined. For example, a table generated and stored according to the process example 1 may be accessed to display a corresponding image thereof, and then, the process example 2 may be conducted on this image and the table maybe updated accordingly. In this way, a combination of the process examples 1 and 2 may be conducted.

In the following, an operation of collectively conducting the same process on plural images is described.

### Another Exemplary Process

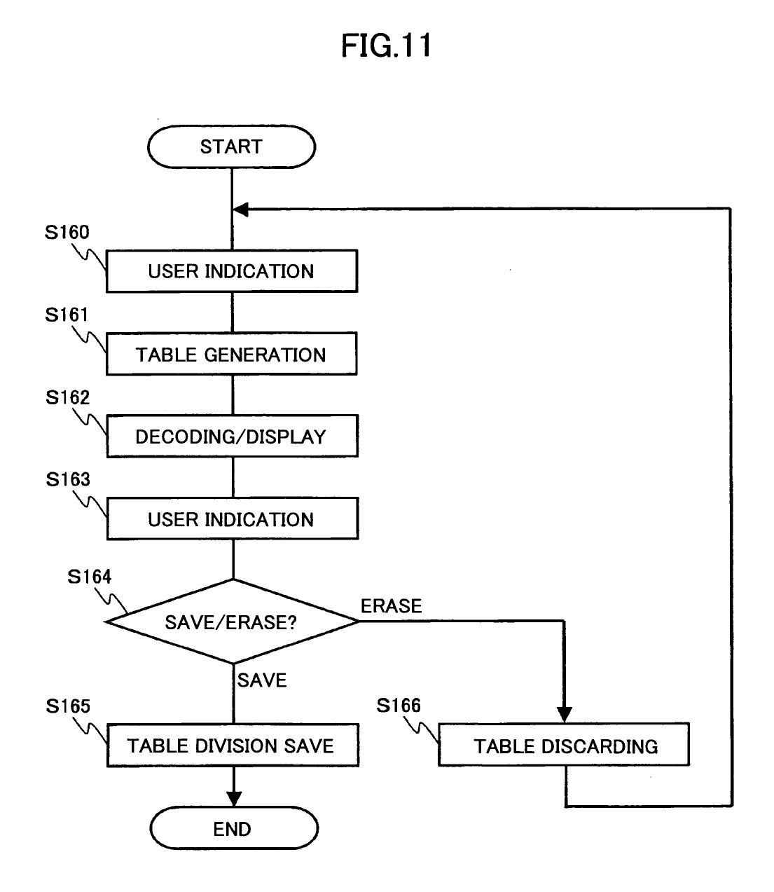

As a fifth example, an operation of collectively conducting a process of extracting and decoding image data of specific tiles on plural images is described. FIG. 11 is a flowchart illustrating the process flow of such an operation.

Before the present operation is executed, plural images subject to processing are selected by the user through the user interface unit 103. For example, the images may be selected from a list of file names or thumbnail images. In another example, a folder may be selected and images included in the folder may be arranged to correspond the images subject to processing. Then, encoded data of one of the selected images are decoded by the data processing unit 101, and the image data of the concerned image are generated at a specific storage area of the data storage unit 100 and displayed by the user interface unit 103. In this case, tile division lines are preferably displayed along with the image.

It is noted that, since the tile division structure maybe determined by analyzing the main header, according to an embodiment the data processing unit 101 may be arranged to merely analyze the main header to display only the tile division lines. Also, it is noted that in a case where the tile division structure is known beforehand, image data indicating the tile division fines corresponding to the tile division structure may be generated at the data processing unit 101 without having to access the encoded data of the image, and the division line image data may be written on a predetermined storage area of the data storage unit 100 so as to be displayed on a screen, for example.

Referring to FIG. 11, in step S160, the user uses the user interface unit 103 to indicate a process to be conducted and one or more tiles to be reproduced. The indication may be made by selecting a command and one or more tiles from a screen through the use of a pointing device such as a mouse. In the present example, it is assumed that four tiles numbered 05, 06, 09, and 10 located at the central portion of the present image are designated.

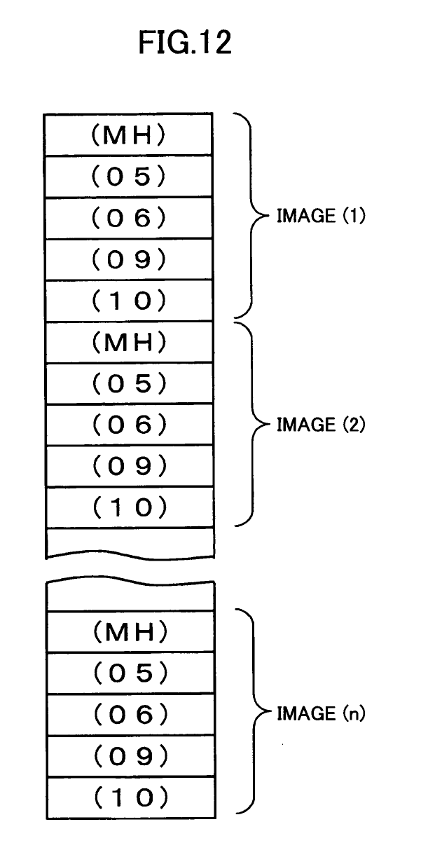

In step S161, the table processing unit 102 generates a table as is shown in FIG. 12 in which tables including entries corresponding to a main header and the designated tiles of the respective images subject to processing are successively coupled (referred to as coupled table hereinafter), such table being generated based on the tables generated upon storing the encoded data of the respective images subject to processing. In this step, a main header is generated by the data processing unit 101 through conducting necessary rewriting processes on the original main header, and the generated main header is stored in the data storage unit 100. Then, the table processing unit 102 writes the storage address information of the generated main header in its corresponding entry within the generated table.

It is noted that in the present example, the positioning of the selected tiles is not changed, and thereby, the position information stored in the entries of the respective tiles remains the same. However, in a case where separately located tiles such as tiles 00, 03, 12, and 15 are designated to be reproduced as a continuous 2×2 tile image, for example, the position information stored in the entries of the respective tiles need to be rewritten.

In step S162, the data processing unit 101 successively refers to the entries of the coupled table starting from the top entry to successively conduct a process of reading and decoding the code data of the main header and the four central tiles of each image and writing the decoded image data on a specific storage area of the storage area unit 100 according to the corresponding position information stored in the entries of the table (it is noted that the initially displayed image data are discarded). In this way, an image made up of the four central tiles of each of the selected images may be successively displayed by the user interface unit 103. The successive display of images as described above may be suitably used for batch processing plural still images that are successively captured by a digital camera, for example. The process of decoding and reproducing selected tiles of selected images may be successively conducted until a command is input by the user.

In another embodiment, the processed image data of the selected images may be stored as separate images in the data storage unit 100, and these images may be displayed according to commands from the user in a manner similar to turning pages of a book, for example. In yet another embodiment, plural images may be displayed at once.

By collectively conducting a process of decoding and reproducing specific tiles of an image on plural images, efficient image processing may be realized.

In step S163, the user may use the user interface unit 103 to indicate whether to save or erase the generated table. Specifically, the user may select a ‘SAVE’ command if he/she wishes to save the generated table, and the user may select an ‘ERASE’ command if he/she wishes to erase the generated command.

If the user selects the ‘SAVE’ command (step S164, SAVE), the table processing unit 102 conducts a process of dividing the coupled table into individual tables corresponding to the respective images and saving each of the divided tables with a new file name (step S165). That is, images each made up of the four designated tiles of a corresponding selected image are saved as different images from their corresponding original images.

In a case where the generated tables pertaining to the respective images are saved in the manner described above, the image of the four central tiles may be displayed as necessary or desired by administering the data processing unit 101 to refer to the saved table to read the code data of the main header and the four tiles and conduct a decoding process on the code data. That is, the present process may correspond to a process of generating another image by extracting specific tiles of an original image. It is noted that the original image also remains stored in the data storage unit 100 so that it maybe reproduced as necessary or desired.

When the user selects the ‘ERASE’ command (step S164, ERASE), the table processing unit 102 conducts a process of discarding the table and the main header generated in step S161 (step S166). In this case, the operation goes back to step S160 where the user may restart the present operation by designating specific tiles to be processed. Also, it is noted that the user may end the processing of the presently selected image by selecting an ‘END’ command.

It is noted that the successive processing of plural images as described above may be similarly applied to code editing processes such as a code reduction process as described in relation to the first process example, a process of converting an image into a monochrome image, or a process of changing the progressive order of encoded image data. Also, the present technique may be applied to tile interchanging processes such as the second and third process examples. Namely, code editing processes for interchanging tiles within an image, or interchanging one or more tiles of one image with those of another image (image synthesis process), for example, may be collectively conducted on code data of plural images.

It is noted that the process examples described above may correspond to image processing methods according to embodiments of the present invention. Also, other embodiments of the present invention include one or more programs for enabling a computer to execute the process steps of any of the process examples describe above, as well as various types of computer readable information recording media storing such programs.

### An Alternative Embodiment

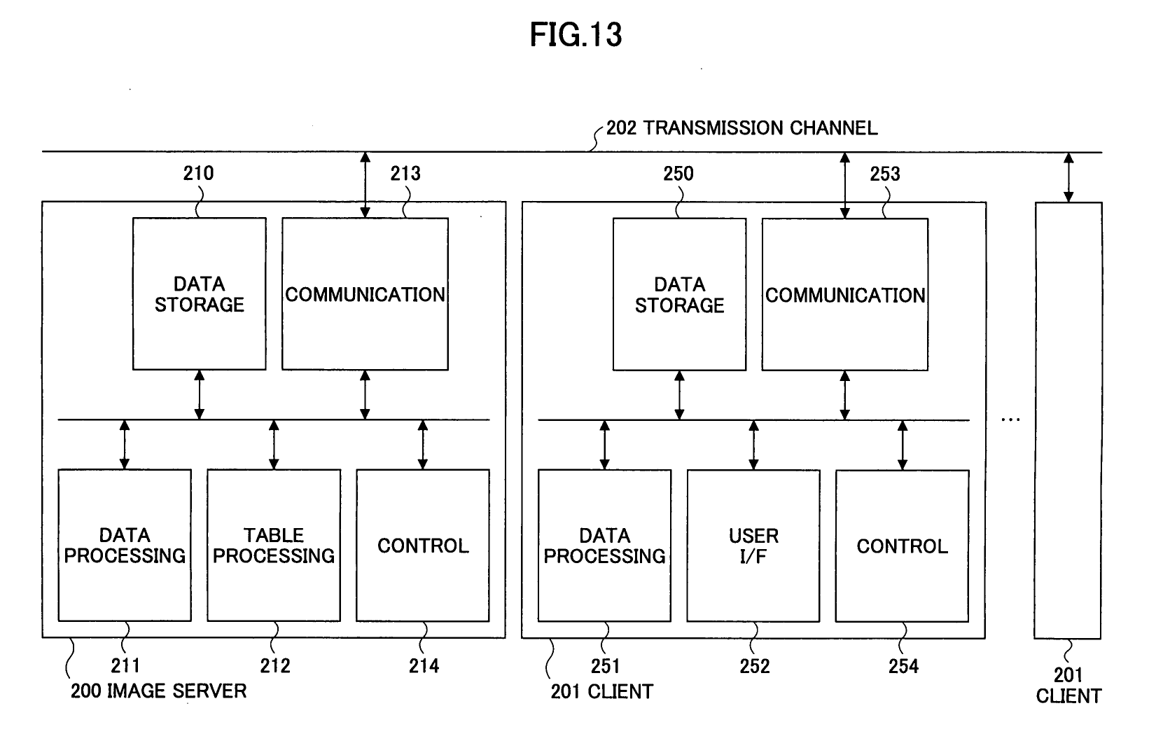

FIG. 13 is a block diagram showing a server/client configuration of an image processing system according to an embodiment of the present invention. The image processing system shown in FIG. 13 includes an image server apparatus (image processing apparatus) 200 and plural client apparatuses 201 that are interconnected by a transmission channel 202. The transmission channel may correspond to a network channel such as a LAN, an intranet, or the Internet.

The image server apparatus 200 includes a data storage unit 210 for storing encoded data of an image, a data processing unit 211 for conducting processes such as code editing on the encoded image data, a table processing unit 212 for generating a table pertaining to an image, a communication unit 213 for establishing communication with the client apparatuses 210 and other external apparatuses via the transmission channel, and a control unit 214 for controlling the operations of the respective units of the image server apparatus 200. It is noted that these units of the image server apparatus 200 are arranged to be able to exchange information with each other.

According to the present embodiment, the data storage unit 210 is arranged to store encoded data of an image that are received by the communication unit 213 from an external apparatus via the transmission channel 202, encoded data of an image input by a local image input apparatus (not shown), or encoded data of image data that are input from an external apparatus and encoded by the data processing unit 211.

It is noted that the encoded image data is arranged to have a data structure that enables processing in image region units, and in the following description, it is assumed that the encoded data correspond to JPEG 2000 encoded data. In JPEG 2000 encoded data, tiles, precincts, and code blocks may be used as image region units. However, in order to simplify the following descriptions, it is assumed that tiles are used as the image region units.

Upon storing encoded data of an image in the data storage unit 210, the table processing unit 212 generates a table pertaining to the relevant image, and the generated table is stored in the data storage unit 210 in association with the encoded data of the image being stored. The generated table may have a configuration as is illustrated in FIG. 3, and the entries of the table may have a configuration as is illustrated in FIG. 4.

The data processing unit 211 maybe arranged to conduct processes of generating transmission data as well as the code editing processes on the encoded image data. The data storage unit 210 may be used as a working memory area for the table processing unit 212 and the data processing unit 211.

The image server apparatus 200 as is described above may typically be realized by one or more programs that are operated on an operating system using a computer including a CPU, a main memory, a large capacity storage unit such as a hard disk unit, a communication interface, and an external interface, for example. In such case, a storage space provided by the main memory or the large capacity storage unit of the computer may be used as the data storage unit 210.

It is noted that embodiments of the present invention include one or more programs for enabling a computer to function as the respective units of the image server apparatus 200 as well-as computer readable information recording media such as a magnetic disk an optical disk, a magneto-optical disk, and a semiconductor memory storing such programs. Also, embodiments of the present invention include one or more programs for enabling a computer to execute operations of the image server apparatus 200, namely, process steps of an image processing method according to an embodiment of the present invention, as well as computer readable information recording media storing such programs.

The client apparatus 201 includes a data storage unit 250 for storing data such as encoded data of an image, a data processing unit 251 for conducting processes such as decoding encoded data of an image, a user interface unit 252 for enabling a user to input various commands through a screen in an interactive manner and/or displaying an image, a communication unit 253 for establishing communication with the image server apparatuses 200 via the transmission channel 202, and a control unit 254 for controlling the operations of the respective units of the client apparatus 210. It is noted that these units of the client apparatus 210 are arranged to be able to exchange information with each other.

The client apparatus 210 as is described above may typically be realized by one or more programs that are operated on an operating system using a computer such as a PC including a CPU, a main memory, an auxiliary storage unit such as a hard disk unit, a communication interface, and an external interface, for example. In such case, a computer display and a user input device maybe used as the user interface 252. Also, a storage space provided by the main memory or the auxiliary storage unit of the computer may be used as the data storage unit 250.

In the image processing system according to the present embodiment, processes such as generating a table pertaining to an image and conducting code editing on encoded data of an image may be executed at the image server apparatus 200, and processes such as decoding the processed encoded data (e.g., edited encoded data) maybe executed at the client apparatus 210.

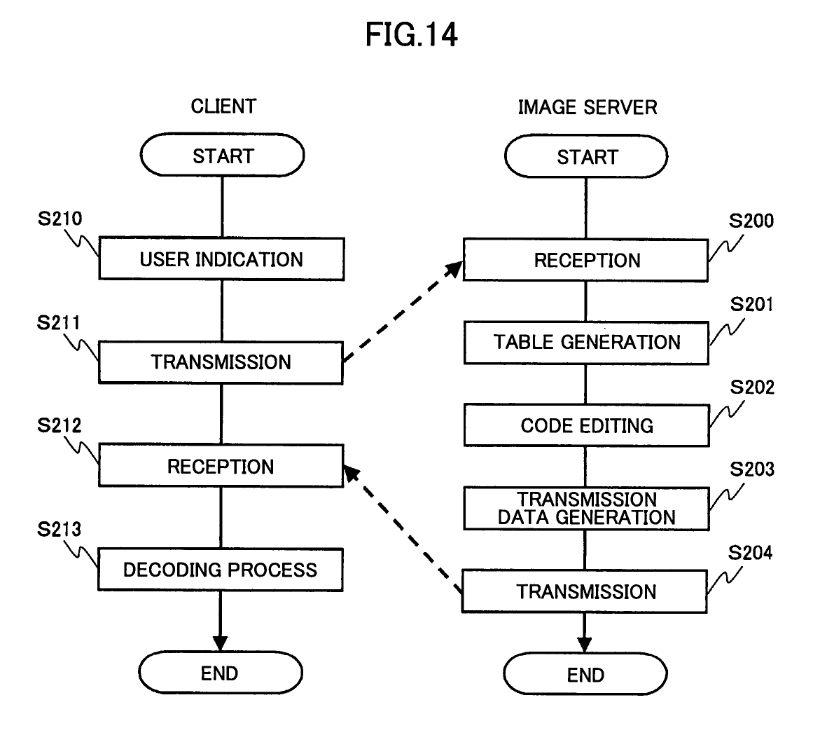

FIG. 14 is a flowchart illustrating the operations of the image server apparatus 200 and the client apparatus 210. In the following, operations of the present system are described with reference to this flowchart. It is noted that the operations of the present system are described in relation to processes identical to the process examples 1 through 5 described in relation to the first embodiment of the present invention.

### Another Exemplary Process

The present process example corresponds to the first process example of the first embodiment, namely, a code editing process for reducing the amount of codes of one or more specified tiles of a selected image.

Before the present process is conducted, a user of the client apparatus 201 uses the user interface unit 252 to select an image subject to processing from a list of file names or thumbnail images, for example. Also, in the present example, it is assumed that the tile division structure (see FIG. 2) of the image is displayed by the user interface unit 252.

According to the present process example, first, in step S210, the user of the client apparatus 210 indicates one or more specific tiles of the image being displayed (indication of the image region subject to processing) and indicates the code reduction process (indication of a process) through the user interface unit 252. For example, the indication may be made using a pointing device such as a mouse to select a uniticular tile or a uniticular processing command from a screen. In the following description, it is assumed that an image that is divided into tiles as is illustrated in FIG. 2 is selected for processing, and the twelve tiles surrounding the outer periphery of the image (i.e., tiles 00˜04, 07, 08, and 11˜15) are designated as image regions subject to processing.

In step S211, the client apparatus 201 uses the communication unit 253 to transmit to the image server apparatus 200 information including the designated process and the file name of the image for which one or more tile numbers have been selected, and in step S200, the image server apparatus 200 receives the transmitted information through the communication unit 213.

In step 201 the table processing unit 211 of the image server apparatus 200 generates a table as is illustrated in FIG. 6. Specifically, the table processing unit 211 rearranges the entries of the table generated at the time the encoded image data are stored (the table shown in FIG. 3) in a manner such that the entries for the tiles designated by the user are arranged to succeed one after the other.

Then, in step S202, the table processing unit 211 of the image server apparatus 200 refers to the entries of the table shown in FIG. 6 starting with the top entry, and based on the storage address information stored in each entry, acquires from the data storage unit 210 code data of the main header and subsequently reads code data of the tiles 00˜04,07,08, and 11˜15 in this order, one tile at a time. Then, a code editing process for reducing the amount of codes is successively conducted on code data of each of the tiles read from the data storage unit 210. The code editing process for reducing the amount of codes as is described above may involve discarding codes (truncation) in layer units or sub bit plane units and rewriting the main header accordingly, for example. According to the present example, in a case of conducting the same process (i.e., code editing process for reducing the amount of codes) on code data of tiles at non-consecutive positions, code data of the tiles subject to processing maybe successively read and processed by referring to the table with the rearranged entries, thereby realizing efficient processing of the tiles.

In step S203, the data processing unit 211 couples the edited code data of the tiles 00˜04, 07, 08, and 11˜15 to the acquired main header in this order, and couples the code data of the rest of the tiles by referring to the rearranged table to generate transmission information. In this process step, information on the table generated in step S201 (i.e., at least the position information of the respective tiles) maybe described in the main header as comment data, for example.

Then, in step S204, the image server apparatus 200 used the communication unit 213 to transmit the transmission data to the client apparatus 201 requesting the transmission data, and in step S212, the client apparatus 201 receives the transmission data through the communication unit 253 and stores the data in the data storage unit 250.

In step S213, the data processing unit 201 of the client apparatus analyzes the main header included in the received data and also extracts table information there from. Then, the data processing unit 201 conducts a process of successively acquiring and decoding the code data of the respective tiles within the received data and writing the decoded data on specific storage areas of the data storage unit 250 according to the position information included in the table information. The image data written on the specific storage areas are then successively displayed on the screen of the user interface unit 252.

It is noted that in this example, a code editing process for reducing the amount of codes is described. However the image server 200 may be arranged to conduct other code editing processes such as discarding codes of the color difference components for one or more specific tiles to display the tile image in monochrome format, changing the progressive order, or decreasing the resolution level, for example, and send the results of the process to the client apparatus 201.

Also, it is noted that after the code editing process is conducted on the peripheral tiles as is described in the present example, another code editing process may be conducted on tiles at the central portion of the image, for example. The positions of the tiles at the central portion (i.e., tiles 05, 06, 09, and 10) are also non-consecutive, but the entries corresponding to these tiles are consecutively arranged within the table so that such process may be efficiently conducted.

It is noted that when rewriting of the main header is required as a result of the code editing process, such rewriting operation may be conducted during the transmission data generation stage (step S203).

It is also noted that in the present example, the table information is arranged to be included in the main header for the sake of efficiency, however, encoded data of the table may be sent to the client apparatus as separate data, for example.

### Another Process Example

The present process corresponds to the second process example of the first embodiment; namely, a process of interchanging specific image regions within the same image.

According to the present example, before stating the present operation, a user of the client apparatus 201 uses the user interface unit 252 to select an image subject to processing from a list of file names or thumbnail images, for example. Also, in this example, it is assumed that a tile division structure of the selected image (see FIG. 2) is displayed.

In step S210, the user of the client apparatus 201 indicates a process to be conducted and a set of tiles to be interchanged using the user interface 252. The indication may be made by selecting a command and a set of tiles from a screen through the use of a pointing device such as a mouse. In the present example, it is assumed that pairs of tiles 00 and 03, 04 and 07, 08 and 11, and 12 and 15 of the tile-divided image of FIG. 2 are designated as tiles that are to be interchanged.

In step S211 the client apparatus 201 uses the communication unit 253 to transit to the image server apparatus 200 information including the designated process and the file name of the image for which a set of tile numbers are selected. In step 200, the image server apparatus 200 receives the transmission information through the communication unit 213.

In step S201, the table processing unit 212 of the image server apparatus 200 generates (duplicates) a table that is identical to the table associated with the selected image (table generated upon storing the encoded data of the relevant image). It is noted that the table referred to in the following description corresponds to this duplicated table. Then, the table processing unit 212 conducts a process of interchanging (exchanging) the storage address information of the entries in the table that correspond to the respective tiles designated for the interchanging process.

FIG. 8 illustrates a table resulting from such an exchanging process. In the table shown in FIG. 8, the entries with the asterisk marks (*) attached thereto correspond to the entries on which the exchanging of storage address information are conducted. Also, each of the entries for which the storage address information is exchanged is divided by a dashed line, wherein the number indicated at the left side of the entry represents storage address information and the number indicated at the right side of the entry represents position information, the respective sets of information being represented in terms of tile numbers for the sake of convenience. For example, the entry corresponding to tile number 00 has the number ‘03’ indicated at its left side, and this means that the storage address information of the present entry has been re-written to include the storage address information of encoded data of the tile 03. It is noted that the position information of the respective entries remains the same.

The code editing process of interchanging designated tiles of an image according to the present example may be substantially completed by conducting the table generation/manipulation process as is described above, and thereby, in this example, the code editing step S202 of FIG. 14 is skipped, and the process moves on to step S203.

In step S203, the data processing unit 211 of the image server apparatus²⁰⁰ successively refers to the entries of the table to successively read the code data of the tiles, and couple the read code data to generate transmission data. It is noted that according to the present process example, the table information does not necessarily have to be transmitted to the client apparatus 201 side.

Then, in step S204, the image server apparatus 200 uses the communication means 213 to transmit the transmission data to the client apparatus 201 that is requesting for the data, and in step S212, the client apparatus 201 receives the data through the communication unit 253 and stores the received data in the data storage unit 250.

In step S213, the data processing unit 251 of the client apparatus 201 analyzes the main header within the received data, after which it successively acquires and decodes the code data of the respective tiles and writes the decoded tile image data on specific storage areas of the data storage unit 250. The image data stored in the specific storage areas may then be successively displayed on the screen of the user interface unit 252. It is noted that in the received data, the code data of the tiles are arranged into the rearranged order, and thereby, an image with interchanged tiles maybe displayed on the screen.

In the above-described example, one tile is interchanged with another tile. However, according to an embodiment, plural tiles may be interchanged by one tile. For example, tiles 01-03 may be interchanged with tile 00. In this case, the storage address information stored in the entries corresponding to the tiles 01-03, respectively, are rewritten to include the storage address information of the code data of tile 00. Accordingly, a tile image identical to that of tile 00 may be indicated at the tile positions of tiles 01-03.

According to another embodiment, in step S201, the position information of the entries corresponding to the designated tiles may be interchanged instead of interchanging the storage address information of the entries. An image with interchanged tile images may similarly be displayed by such a process of interchanging the position information of the designated tiles. In this case, the table information (i.e., at least position information of the respective tiles) may be described in the main header, or the table information may be transmitted as separate data to the client apparatus side. In turn, the client apparatus may decode the data transmitted from the image server apparatus 200 and write the decoded image data of the respective tiles according to the position information of included in the received data.

### Another Exemplary Process

The present process corresponds to the third process example of the first embodiment, namely, a process of interchanging one or more specific tiles of an image subject to processing with one or more specific tiles of at least one other image (referred to as used image hereinafter).

In this example, before the present process is conducted, a user of the client apparatus 201 uses the user interface unit 252 to select an image subject to processing (processing image) and a used image from a list of file names or a thumbnail images, for example. It is also assumed that a tile division structure of the image (see FIG. 2) is displayed along with the image.

In step S210, the user of the client apparatus 201 uses the user interface 252 to indicate a process to be conducted and tiles of the processing image and the used image, respectively, that are to be interchanged. The indication may be made by selecting a command and a set of tiles from a screen through the use of a pointing device such as a mouse. In the present example, it is assumed that four tiles numbered 05, 06, 09, and 10 located at the central portion of the processing image are designated to be interchanged with specific tiles of the used image (e.g., tiles 05, 06, 09, and 10).

In step S211 the client apparatus 201 uses the communication unit 253 to transmit to the image server apparatus 200 information including the designated process and the file name of the image for which a set of tile numbers are selected. In step 200, the image server apparatus 200 receives the transmission information through the communication unit 213.

In step S201, the table processing unit 212 of the image server apparatus 200 generates (duplicates) a table that is identical to that generated upon storing the code data of the relevant image. Then, the table processing unit 212 refers to the table of the processing image (duplicated table) and the table of the used image (the table generated upon storing the encoded data thereof) to rewrite the storage address information of entries corresponding to the tiles of the processing image that are designated for the interchanging process into the storage address information of entries corresponding to the designated tiles of the used image.

FIG. 9 illustrates a table resulting from such a rewriting process. In the table shown in FIG. 9, the storage address information of the entries corresponding to the four designated tiles with the asterisk marks (*) attached thereto are rewritten. In this example, the position information of the respective entries remains the same.

Also, it is noted that since the positioning of the respective tiles is not changed in the present example, the position information of the respective tiles stored in their corresponding entries in the table associated with the processing image may be omitted. That is, in the case of conducting a code editing process as is described above, a table including entries only storing storage address information of the code data of the respective tiles may be used.

The code editing process of interchanging the designated tiles of the processing image with the designated tiles of the used image according to the present example may be substantially completed by conducting the table generation/manipulation process as is described above. Thereby, the process step S202 may be skipped, and the operation may move on to step S203.

In step S203, the data processing unit 211 of the image server apparatus 200 successively refers to the entries of the table associated with the processing image, successively reads and couples the code data of the main header and the respective tiles to generate transmission data. It is noted that in the present process example, the table information does not necessarily have to be transmitted to the client apparatus 201.

Then, in step S204, the image server apparatus 200 uses the communication means 213 to transmit the transmission data to the client apparatus 201 that is requesting for the data, and in step S212, the client apparatus 201 receives the data through the communication unit 253 and stores the received data in the data storage unit 250.

In step S213, the data processing unit 251 of the client apparatus 201 analyzes the main header included in the received data, successively acquires and decodes the code data of the respective tiles, and successively writes the decoded tile image data on specific storage areas of the data storage area 250. In turn, the image data written on the specific storage areas are successively displayed on the screen of the user interface unit 252. Since the received data includes table information in which the code data of the designated tiles are interchanged with the code data of the designated tiles of the used image, an image with interchanged tiles may be displayed on the screen.

### Another Exemplary Process

The present process example corresponds to the fourth process example of the first embodiment, namely, a process of extracting and reproducing a specific region of an image.

Before the present process is executed, a user of the client apparatus 201 uses the user interface unit 252 to select an image subject to processing from a list of file names or thumbnail images. Also, it is assumed that a tile division structure of the image (see FIG. 2) is displayed along with the image.

In step S210, a user of the client apparatus 201 uses the user interface unit 252 to indicate a process to be conducted and one or more tiles to be reproduced. The indication may be made by selecting a command and one or more tiles from a screen through the use of a pointing device such as a mouse. In the present example, it is assumed that four tiles numbered 05, 06, 09, and 10 located at the central portion of the present image are designated to be reproduced.

In step S211 the client apparatus 201 uses the communication unit 253 to transmit to the image server apparatus 200 information including the designated process and the file name of the image for which a set of tile numbers are selected. In step 200, the image server apparatus 200 receives the transmission information through the communication unit 213.

Then, in step S201, the table processing unit 212 of the image generates a table as is shown in FIG. 10 including entries corresponding to a main header and the designated files based on the table generated upon storing the encoded data of the present image (table of FIG. 3). It is noted that in the present example, the positioning of the selected tiles is not changed, and thereby, the position information stored in the entries of the respective tiles remains the same. However, in a case where separately located tiles such as files 00, 03, 12, and 15 are designated to be reproduced as a continuous 2×2 tile image, for example, the position information stored in the entries of the respective tiles need to be rewritten.

In this process example, the code editing process is substantially completed by the above-described table generation/manipulation process, and thereby, the process step S202 may be skipped and the operation may move on to process step S203.

In step S203, the data processing unit 211 of the image server apparatus 200 successively refers to the entries of the table associated with the present image, and successively read and couples the code data of the four tiles at the central portion of the image to generate transmission data. Since the number of tiles is changed in this example, the main header has to be rewritten accordingly. Also, table information (i.e., at least position information of the tiles) may be described in the main header of the transmission data.

Then, in step S204, the image server apparatus 200 uses the communication means 213 to transmit the transmission data to the client apparatus 201 that is requesting for the data, and in step S212, the client apparatus 201 receives the data through the communication unit 253 and stores the received data in the data storage unit 250.

In step S213, the data processing unit 251 of the client apparatus 201 analyzes the main header included in the received data, and extracts the table information included therein. Then, the data processing unit 251 successively acquires and decodes the code data of the respective tiles included in the received data, and successively writes the decoded tile image data on specific storage areas of the data storage area 250 according to their corresponding position information included in the table information. In turn, the image data written on the specific storage areas are successively displayed on the screen of the user interface unit 252. In this way, the image of the four tiles located at the central portion of the original image may be displayed.

### Another Exemplary Process

The present process corresponds to the fifth process example of the first embodiment, namely, an operation involving collectively conducting a process of extracting and decoding image data of specific tiles on plural images. FIG. 11 is a flowchart illustrating the process flow of such an operation.

Before the present operation is executed, a user of the client apparatus 201 uses the user interface unit 252 to select plural images subject to processing from a list of file names or thumbnail images, for example. Also, it is assumed that a tile division structure of the image (see FIG. 2) is displayed along with the selected image.

In step S210, the user uses the user interface unit 252 to indicate a process to be conducted and one or more tiles to be reproduced. The indication may be made by selecting a command and one or more tiles from a screen through the use of a pointing device such as a mouse. In the present example, it is assumed that four tiles numbered 05, 06, 09, and 10 located at the central portion of the present image are designated.

In step S211 the client apparatus 201 uses the communication unit 253 to transmit to the image server apparatus 200 information including the designated process and the file name of the image for which a set of tile numbers are selected. In step 200, the image server apparatus 200 receives the transmission information through the communication unit 213.

Then, in step S201, the table processing unit 211 of the image server apparatus 200 generates a table as is shown in FIG. 12 in which tables including entries corresponding to a main header and the designated tiles of the respective images subject to processing are successively coupled (referred to as coupled table hereinafter), such table being generated based on the tables generated upon storing the encoded data of the respective images subject to processing (see FIG. 3). It is noted that in the present example, the positioning of the selected tiles is not changed, and thereby, the position information stored in the entries of the respective tiles remains the same. However, in a case where separately located tiles such as tiles 00, 03, 12, and 15 are designated to be reproduced as a continuous 2×2 tile image, for example, the position information stored in the entries of the respective tiles need to be rewritten.

In this process example, the code editing process may be substantially completed by the table generation process as is described above, and thereby, step S202 may be skipped and the operation may move on to the next step S203.

In step S203, the data processing unit 211 of the image server apparatus 200 successively refers to the entries of the table associated with the present image, and successively read and couples the code data of the four tiles at the central portion of the image to generate transmission data. Since the number of tiles is changed in this example, the main header has to be rewritten accordingly. Also, table information (i.e., at least position information of the tiles) may be described in the main header of the transmission data.

Then, in step S204, the image server apparatus 200 uses the communication means 213 to transmit the transmission data to the client apparatus 201 that is requesting for the data, and in step S212, the client apparatus 201 receives the data through the communication unit 253 and stores the received data in the data storage unit 250.

In step S213, the data processing unit 251 of the client apparatus 201 analyzes the main header included in the received data and extracts the table information therefrom. Then the data processing unit 251 successively acquires and decodes the code data of the respective tiles, and successively writes the decoded tile image data on specific storage areas of the data storage area 250. In turn, the image data written on the specific storage areas are successively displayed on the screen of the user interface unit 252. In this way, an image made up of the four central tiles of a selected image may be successively displayed.

It is noted that in one embodiment, the plural images subject to processing may be successively displayed. In another embodiment, the images may be displayed according to commands from the user in a manner similar to turning pages of a book, for example. In yet another embodiment, plural images may be displayed at once. The sequential display of plural images may be suitable for batch processing plural still images that are successively captured by a digital camera, for example.

According to the present process example, a process of editing a specific image region (specific tiles), decoding the code data of this image region, and reproducing the decoded image data may be collectively conducted on plural images so that efficient processing of the images may be realized.

It is noted that batch processing of plural images as is describe above may be applied to other various code editing processes such as the code reducing process as is described in relation to the sixth process example, a process of converting an image into a monochrome image, a process of changing the progressive order of image data, or a tile interchanging process including the seventh process example of interchanging specific tiles within the same image and the eighth process example of interchanging a specific tile of one image with a specific tile of another image (image synthesis).

It is noted that the process examples described above may correspond to process steps of image processing methods according to embodiments of the present invention. Also, other embodiments of the present invention include one or more programs for enabling a computer to execute the process steps of any of the process examples describe above, as well as various types of computer readable information recording media storing such programs. It is further noted that international standardization of an Internet protocol for the JPEG 2000 scheme (JPIP: JPEG 2000 Interactive Protocol) is presently being developed. According to JPIP, a function is required for enabling access to code data of a given image region of an image being displayed in response to the designation of the given image region. According to an embodiment of the present invention, a table is generated that stores entries corresponding to the respective image regions of an image, each entry storing position information of the image region and storage address information of code data of the image region. By using such a table, code data of a given image region may be easily accessed. Accordingly, an embodiment of the present invention may be suitably used in applications of JPIP.

Further, the present invention is not limited to these embodiments, and variations and modifications may be made without departing from the scope of the present invention.

The present application is based on and claims the benefit of the earlier filing date of Japanese Patent Application No. 2004-009618 filed on Jan. 16, 2004, and Japanese Patent Application No. 2004-326084 filed on Nov. 10, 2004, the entire contents of which are hereby incorporated by reference.

1. An image processing apparatus for processing encoded image data having a data structure that enables data processing in image region units, the apparatus comprising:
a storage unit to store encoded data of an image; and
a table processing unit to generate a first table for the image stored in the data storage unit, the first table including a plurality of entries corresponding to image regions of the image, each of the entries including storage address information of code data of a corresponding one of the image regions and position information of the corresponding image region.

2. The image processing apparatus as claimed in claim 1, wherein when the image is subject to processing, the table processing unit generates a second table for the image, the second table including a plurality of entries corresponding to image regions subject to a same process that are consecutively arranged.

3. The image processing apparatus as claimed in claim 2, further comprising:
a data save processing unit to store the second table generated by the table processing unit.

4. The image processing apparatus as claimed in claim 1, wherein when the image is subject to processing, the table processing unit generates a second table for the image, the second table including one or more entries corresponding to one or more specific image regions of the image that are deleted.

5. The image processing apparatus as claimed in claim 4, further comprising:
a data save processing unit to store the second table generated by the table processing unit.

6. The imaging apparatus as claimed in claim 1, wherein when the image is subject to processing, the table processing unit generates a second table for the image, the second table including an entry corresponding to a specific image region of the image that includes storage address information of code data of another specific image region of the image.

7. The image processing apparatus as claimed in claim 6, further comprising:
a data save processing unit to store the second table generated by the table processing unit.

8. The imaging apparatus as claimed in claim 1, wherein when the image is subject to processing, the table processing unit generates a second table for the image, the second table including an entry corresponding to a specific image region of the image that includes position information of another specific image region of the image.

9. The image processing apparatus as claimed in claim 8, further comprising:
a data save processing unit to store the second table generated by the table processing unit.

10. The imaging apparatus as claimed in claim 1, wherein when the image is subject to processing, the table processing unit generates a second table for the image, the second table including an entry corresponding to a specific image region of the image that includes storage address information of code data of another specific image region of another image.

11. The image processing apparatus as claimed in claim 10, further comprising:
a data save processing unit to store the second table generated by the table processing unit.

12. The image processing apparatus as claimed in claim 1, wherein when a plurality of the images are subject to processing, the table processing unit generates a second table for the images, the second table including a plurality of tables are coupled to one another, each of the tables including one or more entries corresponding to one or more image regions of a corresponding one of the images.

13. The image processing apparatus as claimed in claim 12, further comprising:
a data save processing unit to store the second table generated by the table processing unit.

14. The image processing apparatus as claimed in claim 1, further comprising:
a communication unit to establish communication with an external apparatus via a transmission channel; wherein
when the image is processed, information pertaining to the second table generated for the image is attached to encoded data of the processed image and transmitted to the external apparatus by the communication unit.

15. An image processing method for reading from a storage unit and processing encoded data of an image, the encoded data having a data structure that enables data processing in image region units, the method comprising:
generating a first table for the image to be processed, the first table including a plurality of entries corresponding to image regions of the image, each of the entries including storage address information of code data of a corresponding one of the image regions and position information of the corresponding image region.

16. The image processing method as claimed in claim 15, wherein generating the first table includes generating a second table for the image, the second table including a plurality of entries corresponding to image regions subject to a same process that are consecutively arranged.

17. The image processing method as claimed in claim 15, wherein generating the first table includes generating a second table for the image, the second table including one or more entries corresponding to one or more specific image regions of the image that are deleted.

18. The image processing method as claimed in claim 15, wherein generating the first table includes generating a second table for the image, the second table including an entry corresponding to a specific image region of the image that includes storage address information of code data of another specific image region of the image.

19. The image processing method as claimed in claim 15, wherein generating the first table includes generating a second table for the image, the second table including an entry corresponding to a specific image region of the image that includes position information of another specific image region of the image.

20. The image processing method as claimed in claim 15, wherein generating the first table includes generating a second table for the image, the second table including an entry corresponding to a specific image region of the image that includes storage address information of code data of another specific image region of another image.

21. The image processing method as claimed in claim 15, wherein generating the first table comprises generating a second table for a plurality of the images, the second table including a plurality of tables that are coupled to one another, each of the tables including one or more entries corresponding to one or more image regions of a corresponding one of the images.

22. A computer readable information recording medium storing a program that is run on a computer to execute a method for processing encoded data of an image, the encoded data having a data structure that enables data processing in image region units, the method comprising:
generating a first table for the image to be processed, the first table including a plurality of entries corresponding to image regions of the image, each of the entries including storage address information of code data of a corresponding one of the image regions and position information of the corresponding image region.
